(19) United States
(12) Patent Application Publication
(10) Pub. No.: US 2008/0062060 A1
(43) Pub. Date: Mar. 13, 2008

(54) ANTENNA AND RECEIVER HAVING THE SAME

(76) Inventors: Junichi NORO, Akita (JP); Takao KATO, Akita (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/829,312

(22) Filed: Jul. 27, 2007

(30) Foreign Application Priority Data
Sep. 13, 2006 (JP) P2006-247453
Sep. 19, 2006 (JP) P2006-252870

(51) Int. Cl. H01Q 1/52; H01Q 1/12

(52) U.S. Cl. 343/842; 343/841; 343/878

(57) ABSTRACT

A circuit board has a first face and a second face opposite to the first face. A low noise amplifier is mounted on the second face. A pole-type antenna module is extending vertically along a central axis thereof A shield cover is attached to the second face of the circuit board so as to cover the low noise amplifier. The circuit board is formed with a through hole connecting the first face and the second face. The pole-type antenna module is inserted into the through hole so that a lower part thereof is accommodated in the shield cover and an upper part thereof is protruded from the first face of the circuit board.

The disclosures of Japanese Patent Application No. 2006-247453 filed Sep. 13, 2006, and Japanese Patent Application No. 2006-252870 filed Sep. 19, 200 including specifications, drawings and claims are incorporated herein by reference in its entireties.

### BACKGROUND

The present invention relates to an antenna device. More particularly, the present invention relates to a personal-type antenna device for a digital radio receiver for receiving an electric wave from an artificial satellite (hereinafter, referred to as a “satellite wave”) or an electric wave on the ground (hereinafter, referred to as a “terrestrial wave”) to listen in digital radio broadcasting onto a circuit board (an LNA board). The present invention also relates to a receiver having the above antenna device. The present invention also relates to an attachment structure of a pole-type antenna module for the digital radio receiver onto a circuit board (an LNA board).

In recent years, a digital radio receiver, which receives the satellite wave or the terrestrial wave to listen in digital radio broadcasting, has been developed and is put to practical use in the United States of America. The digital radio receiver is generally mounted on a mobile station such as an automobile and can receive an electric wave having a frequency band of about 2.3 GHz to listen in radio broadcasting. That is, the digital radio receiver is a radio receiver which can listen in mobile broadcasting. The frequency band of the received radio waves is in the range of about 2.3 GHz and a reception wavelength (a resonant wavelength) λ is in the range of about 128.3 mm. The terrestrial wave is an electric wave in which a signal where the satellite wave received in an earth station is frequently shifted a little and is retransmitted in the form of a linearly polarized wave. That is, the satellite wave is a circularly-polarized wave while the terrestrial wave is the linearly-polarized wave.

As described above, since electric waves having the frequency band of about 2.3 GHz is used for the digital radio broadcasting, it is necessary to set up an antenna for receiving the electric waves outside the automobile.

The digital radio receiver includes a digital radio receiver mounted on the automobile, a digital radio receiver installed in a house, and a portable mobile digital radio receiver using a battery as a power supply. The portable mobile digital radio receiver may have the antenna device incorporated in a casing thereof.

A mobile electronic apparatus such as a mobile audio apparatus is provided as a specific example of the mobile digital radio receiver. In the mobile electronic apparatus, an optical disk drive for reproducing an optical disk such as a compact disk (CD), an amplifier, and a speaker are integrally built in a chassis thereof in addition to a digital tuner for receiving the digital radio broadcasting.

Meanwhile, there have been proposed antennas having various structures as an antenna receiving the radio waves having the frequency band of about 2.3 GHz. In accordance with shapes of the antennas, the antennas are generally classified into a planar (a plane) antenna such as a patch antenna and a cylindrical antenna such as a loop antenna or a helical antenna. The planar antenna or the cylindrical antenna may be incorporated in the casing of the portable mobile digital radio receiver. On the other hand, the planar antenna or the cylindrical antenna may be provided separately from the chassis of the mobile electronic apparatus described above. The planar antenna or the cylindrical antenna is connected to the digital radio tuner built in the chassis through a cable or a connector.

In general, the cylindrical antenna is used rather than the planar antenna. It is possible to achieve a wider directivity by making a shape of the antenna cylindrical. As described above, the cylindrical antenna is generally classified into the loop antenna and the helical antenna.

An electromagnetic coupling type four-point feeding loop antenna has been known as the loop antenna (for example, see Japanese Patent Publication No. 2003-298335A). The electromagnetic coupling type four-point feeding loop antenna disclosed in the Japanese Patent Publication No. 2003-298335A has a cylindrical body formed by winding a flexible dielectric film member about a central axis, a loop section formed on the cylindrical body along a peripheral surface thereof about the central axis, and four power feeding lines formed on the peripheral surface of the cylindrical body to feed the loop section. Four electromagnetic coupling lines extending along four power feeding lines from the loop section with gaps of the electromagnetic coupling lines are connected to the four power feeding lines of the loop section. The loop section is fed by electromagnetic coupling. In the loop antenna, an earth conductive pattern is formed on a rear surface of a circuit board extending in a direction perpendicular to the central axis.

Meanwhile, the helical antenna has been known as the loop antenna (for example, see Japanese Patent Publication No. 2003-37430A). In the Japanese Patent Publication No. 2003-37430A, the flexible dielectric film member having an antenna pattern formed of four helix wires printed on one surface thereof (hereinafter, referred to as a “dielectric film member with the antenna pattern”) is manufactured and the dielectric film member with the antenna pattern is cylindrically wound about the central axis so that the one surface serves as an outer peripheral surface, whereby the helical antenna is manufactured. Even in the helical antenna, the earth conductive pattern is formed on the rear surface of the circuit board extending in the direction perpendicular to the central axis.

In the case of the cylindrical antenna, after a plurality of satellite waves (circularly-polarized waves) received through the four electromagnetic coupling lines or received through the helix wires from the loop section is synthesized by shifting phases of the satellite waves with a phase shifter and matching (adjusting) the phases each other, the synthesized waves are amplified by a low noise amplifier (LNA: Low Noise Amplifier) and the amplified waves are transmitted to a receiver body. Here, a combination of the helical antenna and the phase shifter is called an antenna module and a combination of the helical antenna, the phase shifter, and the low noise amplifier (LNA) is called an antenna device.

There is proposed the antenna module including the helical antenna including the antenna pattern formed on the outer peripheral surface of the cylindrical member and the phase shifter including a phase shifter pattern followed by (connected to) the antenna pattern on the peripheral surface of the cylindrical member (for example, see Japanese Patent Publication No. 2001-339228A).

The antenna module has the chassis formed by winding the flexible dielectric film member about the central axis in the cylindrical fashion, whereby the antenna module is called a pole-type antenna module.

FIG. 1 illustrates a related-art antenna device 10 including the pole-type antenna module. The antenna device 10 includes a pole-type antenna module 20, a circuit board 30, and a shield cover 40.

The circuit board 30 includes a principal surface (a top surface) 30a and a rear surface (a bottom surface) 30b opposite the principal surface. The pole-type antenna module 20 is mounted on the principal surface 30a of the circuit board 30. The low noise amplifier (LNA) (not shown) is mounted on the rear surface 30b of the circuit board 30. Accordingly, the circuit board 30 is also called an “LNA board”. The LNA is covered with a shield cover 40 attached to the rear surface 30b of the circuit board 30.

FIG. 2 illustrates a related-art handy digital radio receiver 50 having the related-art antenna device 10 shown in FIG. 1, which is incorporated therein. The digital radio receiver 50 has a substantially rectangular parallelepiped casing 51. The antenna device 10 shown in FIG. 1 and a receiver body 60 are incorporated in the casing 51. The antenna device 10 is disposed in an upper end of the casing 51. As a result, the casing 51 includes a capitate cylindrical antenna cover section 52 protruding upward from an upper end 51a of an upper left corner thereof. In other words, the antenna cover section 52 protrudes from the upper end 51a of the casing 51. The antenna cover section 52 covers the pole-type antenna module 20 of the antenna device 10. The antenna cover section 52 includes an antenna stroke Hc1 extending upward from the upper end 51a of the casing 51. That is, the antenna cover section 52 projects from the casing 51 by a length of antenna stroke Hc1.

The above-mentioned related-art handy digital radio receiver 50 includes an antenna cover section 52 protruding (projecting) from an upper end 51a of an upper left corner of a casing 51 by an antenna stroke Hc1 so as to have an antenna device 10 incorporated therein.

In order to achieve a decrease in size of the handy digital radio receiver 50, it is necessary to the antenna stroke Hc1 of the antenna cover section 52 as much as possible. However, since the related-art antenna device 10 has a structure in which the pole-type antenna module 20 is erected on the principal surface 30a of the LNA board 30, it is necessary that the antenna stroke Hc1 of the antenna cover section 52 is larger than a height H1 of the pole-type antenna module 20 (Hc1>H1). As a result, there is an obstacle to achieve the decrease in size of the handy digital radio receiver 50. Since the antenna cover section 52 protrudes (projects) from the upper end 51a of the upper left corner of the casing 51 by the antenna stroke Hc1 in the related-art handy digital radio receiver 50, the related-art handy digital radio receiver 50 makes an ill appearance.

In the Japanese Patent Publication No. 2001-339228A, an antenna device is configured by erecting a pole-type antenna module having a helical antenna pattern and a phase shifter pattern formed in a cylindrical body (a cylindrical member) thereof on a principal surface of a circuit board having a low noise amplifier (LNA) mounted on a rear surface thereof The circuit board having the LNA mounted thereon is called an LNA board. On the other hand, the pole-type antenna module is vertically erected on the principal surface of the LNA substrate extending in the direction perpendicular to the central axis of the cylindrical body (the cylindrical member). That is, the antenna device is configured by is vertically erecting the pole-type antenna module on the principal surface of the LNA board.

However, since the cylindrical body (the cylindrical member) is formed by winding the flexible dielectric film member about the central axis as described above, the strength of the cylindrical body is low, whereby it is very difficult to vertically erect the pole-type antenna module on the principal surface of the LNA board. There is a problem that the pole-type antenna module erected on the LNA board is vibrated due to a vibration.

### SUMMARY

It is therefore an object of the invention to provide an antenna device which is capable of reducing a length of an antenna stroke of the antenna cover section projecting from a casing of a receiver and a receiver having the antenna device incorporated therein.

It is another object of the invention to provide a receiver having an improved appearance.

It is a further object of the invention to provide an antenna device in which the pole-type antenna module can be easily erected on the LNA board vertically.

It is a still further object of the invention to provide an antenna device in which the pole-type antenna module can be securely attached to and fixed on the LNA board to resist the vibration.

In order to achieve the above objects, according to a first aspect of the invention, there is provided an antenna device comprising:

a circuit board, having a first face and a second face opposite to the first face, the second face on which a low noise amplifier is mounted;

a pole-type antenna module, extending vertically along a central axis thereof; and

a shield cover, attached to the second face of the circuit board so as to cover the low noise amplifier, wherein:

the circuit board is formed with a through hole connecting the first face and the second face; and

the pole-type antenna module is inserted into the through hole so that a lower part thereof is accommodated in the shield cover and an upper part thereof is protruded from the first face of the circuit board.

In the antenna device according to the first aspect of the invention, the through hole may have substantially the same shape as the outer shape of the pole-type antenna module. The pole-type antenna module may include a cylindrical body formed by winding a flexible dielectric film member about the central axis, an antenna pattern having a plurality of lines of conductors formed on a peripheral surface of the cylindrical body in the upper part, and a phase shifter pattern formed on the peripheral surface of the cylindrical body in the lower part and electrically connected to the antenna pattern. The antenna pattern may include a helical pattern spirally extending in a direction of the central axis, and a loop pattern formed on an upper end of the cylindrical body and electrically connected to an end of the helical pattern. The helical pattern may include a bend portion bent at least once in a direction opposite to the direction of the central axis. The helical pattern may include a meander portion having a meander shape. The antenna pattern and the phase shifter pattern may be formed on an inner peripheral surface of the cylindrical body; and the pole-type antenna module may further include ground pattern formed on an outer peripheral surface of the cylindrical body in the lower part.

According to a second aspect of the invention, there is provided a receiver, comprising:

the antenna device as set forth in claim 1;

a casing, accommodating the antenna device; and

an antenna cover, covering the pole-type antenna module and protruded from an upper end of the casing.

According to the first and second aspect of the invention, a through-hole having the substantially same shape as an outer shape of a pole-type antenna module is disposed on a circuit board, a lower part of the pole-type antenna module is inserted in a shield cover by penetrating the through-hole, whereby the pole-type antenna module is mounted on the circuit board. Therefore, it is possible to reduce a length of the pole-type antenna module protruding from a first face of the circuit board. Since it is possible to reduce a length of an antenna stroke of an antenna cover section projecting from a casing of a receiver, it is possible to improve an appearance of the receiver.

According to a third aspect of the invention, there is provided an antenna device comprising:

a low noise amplifier board, having a first face and a second face opposite to the first face, the second face on which a low noise amplifier is mounted;

a pole-type antenna module, extending vertically along a central axis thereof and mounted on the first face of the low noise amplifier board, the pole-type antenna module including a cylindrical body formed by winding a flexible dielectric film member about the central axis; and

a metal bracket, supporting an outer peripheral surface of the cylindrical body of the pole-type antenna module so as to attach the pole-type antenna module onto the first face of the low noise amplifier board.

The metal bracket may have a ring-shaped portion, an inner diameter of which is substantially the same as an outer diameter of the cylindrical body and covering a lower part of the outer peripheral surface of the cylindrical body. The pole-type antenna module may have an elongated module extension portion extending from a lower peripheral end of the cylindrical body, the metal bracket may have a holder extension portion extending from a lower peripheral end of the ring-shaped portion, and the holder extension portion may be disposed along the module extension portion so as to support the module extension portion. The module extension portion may include horizontal module extension portion extending from the lower peripheral end of the cylindrical body toward inside of the cylindrical body and vertical module extension portion extending vertically downward from a tip end of the horizontal module extension portion in a direction of the central axis, and the holder extension portion may include horizontal holder extension portion extending from the lower peripheral end of the ring-shaped portion toward inside of the ring-shaped portion and vertical module extension portion extending vertically downward from a tip end of the horizontal holder extension portion in the direction of the central axis. The low noise amplifier board may be formed with a through hole through into which the vertical module extension portion and the vertical holder extension portion are inserted.

The pole-type antenna module may include an antenna pattern having a plurality of lines of conductors formed on a peripheral surface of the cylindrical body in an upper part thereof, and a phase shifter pattern formed on the peripheral surface of the cylindrical body in the lower part and electrically connected to the antenna pattern. The antenna pattern may include a helical pattern spirally extending in the direction of the central axis, and a loop pattern formed on an upper end of the cylindrical body and electrically connected to an end of the helical pattern. The helical pattern may include a bend portion bent at least once in a direction opposite to the direction of the central axis. The helical pattern may include a meander portion having a meander shape. The antenna pattern and the phase shifter pattern may be formed on an inner peripheral surface of the cylindrical body, and the pole-type antenna module may further include ground pattern formed on the outer peripheral surface of the cylindrical body in the lower part. The ground pattern may be electrically connected to the ring-shaped portion of the metal bracket.

According to the third aspect of the invention, since an antenna device includes a metal bracket supporting an outer peripheral surface of a cylindrical body of the pole-type antenna module so as to attach a pole-type antenna module onto an first face of an LNA board, it is possible to vertically erect the pole-type antenna module on the LNA board easily and to securely attach and fix the pole-type antenna module to and on the LNA board to resist a vibration.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a front view illustrating a related-art antenna device;

FIG. 2 is a front view illustrating a related-art receiver having the antenna device shown in FIG. 1, which is incorporated therein;

FIG. 3 is a front view illustrating an antenna device according to a first embodiment of the invention;

FIG. 4 is a plan view illustrating a circuit board used for the antenna device shown in FIG. 3;

FIG. 5 is a front view illustrating a receiver according to the first embodiment of the invention having the antenna device shown in FIG. 3, which is incorporated therein;

FIG. 6 is a front view illustrating a pole-type antenna module used for the antenna device shown in FIG. 3;

FIGS. 7(A) and 7(B) are development views of the pole-type antenna module shown in FIG. 6, FIG. 7(A) is a plan view illustrating a first surface (an inner peripheral surface) and FIG. 7(B) is a plan view illustrating a second surface (an outer peripheral surface);

FIG. 8 is a partial sectional front view of an antenna device according to a second embodiment of the invention;

FIGS. 9(A) and 9(B) are development views illustrating a first example of a pole-type antenna module used for the antenna device shown in FIG. 8, FIG. 9(A) is a plan view illustrating a first surface (an inner peripheral surface) and FIG. 9(B) is a plan view illustrating a second surface (an outer peripheral surface);

FIG. 10 is an exploded perspective view illustrating a pole-type antenna module and an attachment bracket (holder) used for the antenna device shown in FIG. 8.

FIG. 11 is a partial enlarged perspective view illustrating a combination status of the pole-type antenna module and the attachment bracket (holder) which are shown in FIG. 10;

FIGS. 12(A) and 12(B) are development views illustrating a second example of a pole-type antenna module used for the antenna device shown in FIG. 8, FIG. 12(A) is a plan view illustrating a first surface (an inner peripheral surface) and FIG. 12(B) is a plan view illustrating a second surface (an outer peripheral surface);

FIG. 13 is a perspective view of the pole-type antenna module shown in FIGS. 12(A) and 12(B);

FIGS. 14(A) and 14(B) are development views illustrating a third example of a pole-type antenna module used for the antenna device shown in FIG. 8. FIG. 14(A) is a plan view illustrating a first surface (an inner peripheral surface) and FIG. 14(B) is a plan view illustrating a second surface (an outer peripheral surface); and

FIG. 15 is a front view illustrating the pole-type antenna module shown in FIGS. 14(A) and 14(B).

### DETAILED DESCRIPTION OF THE EMBODIMENTS

Hereinafter, a first embodiment of the invention will be described in detail with reference to the accompanying drawings.

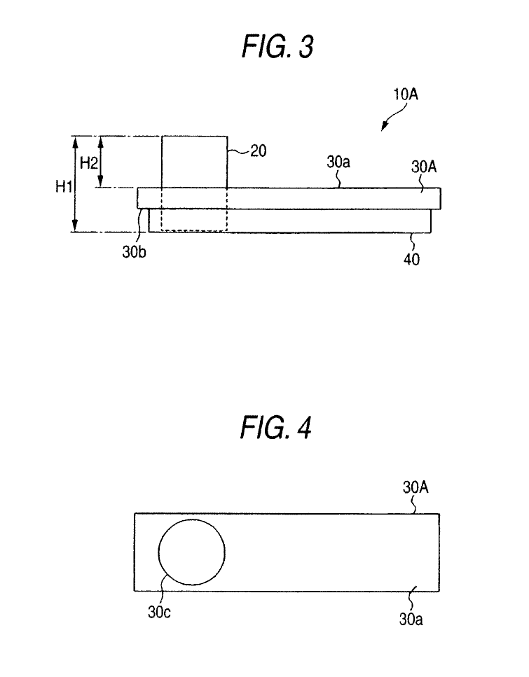

Referring to FIGS. 3 and 4, an antenna device 10A according to a first embodiment of the invention is described. FIG. 3 is a front view of the antenna device 10A and FIG. 4 is a plan view of a circuit board 30A used for the antenna device 10A.

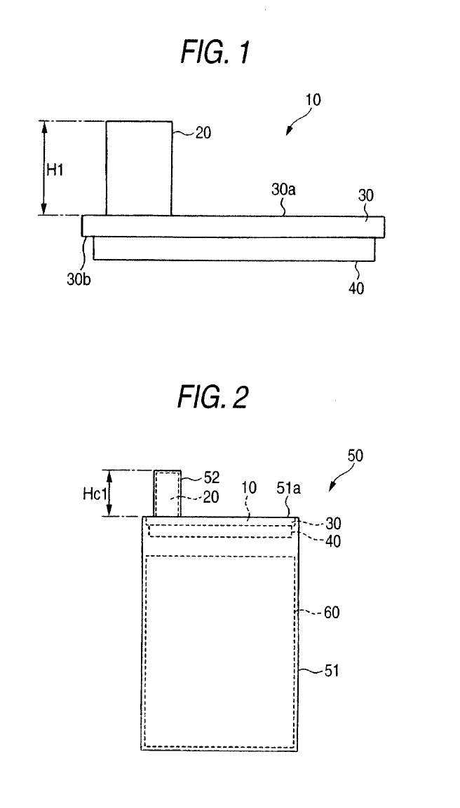

The antenna device 10A shown in the figure includes a pole-type antenna module 20, the circuit board (LNA board) 30A, and a shield cover 40. That is, as described below, the antenna device 10A has the same configuration as the antenna device 10 shown in FIG. 1 except that the circuit board (LNA board) 30 is replaced with the circuit board (LNA board) 30A.

The circuit board 30A includes a principal surface (a top surface) 30a and a rear surface (a wall surface) 30b opposite the principal surface. As shown in FIG. 4, the circuit board 30A is substantially equal to or slightly larger than an outer shape of the pole-type antenna module 20. The circuit board 30A includes a through-hole 30c vertically penetrating the principal surface 30a and the rear surface 30b. The low noise amplifier (LNA) (not shown) is mounted on the rear surface 30b of the circuit board (LNA board) 30. The LAN is covered with the shield cover 40 attached onto the rear surface 30a of the circuit board (LNA board) 30. The pole-type antenna module 20 extends vertically along a central axis and is mounted on the circuit board 30A as described above.

As shown in FIG. 3, the pole-type antenna module 20 is mounted on the circuit board 30A with penetrating the through-hole 30c of the circuit board 30A. Specifically, the pole-type antenna module 20 has a lower part that is inserted into the shield cover 40 through the through-hole 30c and an upper part that is mounted on the circuit board 30A with protruding from the principal surface 30a of the circuit board 30A.

In the related-art antenna device 10 shown in FIG. 1, the pole-type antenna module 20 protrudes upward from the principal surface 30a of the circuit board 30 by a height H1. The height H1 is equal to a height (length) H1 of the pole-type antenna module 20. On the contrary, in the antenna device 10A shown in FIG. 3, the pole-type antenna module 20 protrudes upward from the principal surface 30a of the circuit board 30 by a height H2. The height H2 is equal to a height acquired by subtracting a length adding a thickness of the circuit board 30A to a thickness of the shield cover 40 from the height (length) H1 of the pole-type antenna module 20. That is, in the antenna device 10A according to the first embodiment of the invention, it is possible to reduce (decrease) a length of the pole-type antenna module 20 projecting from the principal surface of the circuit board in comparison with the related-art antenna device 10 (H2<H1).

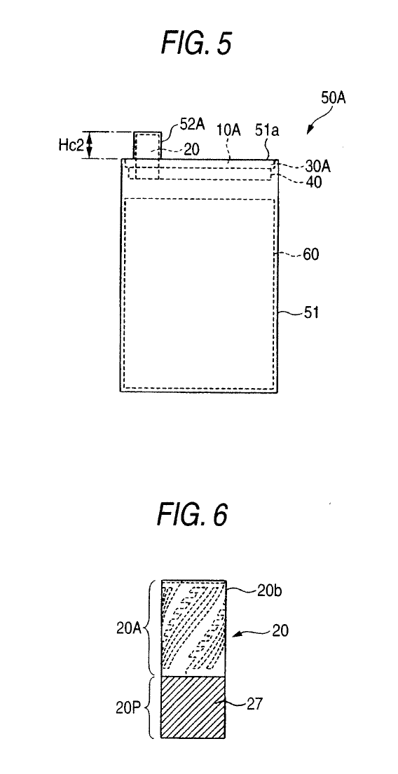

FIG. 5 illustrates a handy digital radio receiver 50A having the antenna device 10A shown in FIG. 3, which is incorporated therein. The digital radio receiver 50A has a substantially rectangular parallelepiped casing 51. The antenna device 10A shown in FIG. 3 and a receiver body 60 are incorporated in the casing 51. The antenna device 10A is disposed in an upper end of the casing 51. As a result, the casing 51 includes a capitate cylindrical antenna cover section 52A protruding upward from an upper end 51a of an upper left corner thereof. In other words, the antenna cover section 52A protrudes from the upper end 51a of the casing 51. The antenna cover section 52A covers a pole-type antenna module 20A of the antenna device 10A.

In a receiver 50 shown in FIG. 2, an antenna cover section 52 includes an antenna stroke Hc1 extending upward from the upper end 51a of the casing 51. That is, the antenna cover section 52 projects from the casing 51 by a length of the antenna stroke Hc1. The antenna stroke Hc1 is higher than the height H1 of the pole-type antenna module 20 (Hc1>H1).

On the contrary, in the receiver 50A shown in FIG. 5, the antenna cover section 52A includes an antenna stroke Hc2 extending upward from the upper end 51a of the casing 51. That is, the antenna cover section 52A projects from the casing 51 by a length of the antenna stroke Hc2. The antenna stroke Hc2 is lower than the height H1 of the pole-type antenna module 20 (Hc2>H1). The reason is that a protrusion length H2 of the antenna cover section 52A protruding from the principal surface 30a of the circuit board 30A in the antenna device 10A is lower (smaller) than the height H1 of the pole-type antenna module 20.

For this reason, it becomes possible to achieve a decrease in size of the handy digital radio receiver 50A in comparison with the related-art handy digital radio receiver 50 (shown in FIG. 2).

In the related-art handy digital radio receiver 50 shown in FIG. 2, since the antenna cover section 52 protrudes (projects) upward from the upper end 51a of the upper left corner of the casing 51 by the antenna stroke Hc1, the related-art handy digital radio receiver 50 makes an ill appearance. On the contrary, in the related-art handy digital radio receiver 50A shown in FIG. 5, since the antenna cover section 52A protrudes (projects) downward from the upper end 51a of the upper left corner of the casing 51 by the antenna stroke Hc2, the related-art handy digital radio receiver 50A makes an ill appearance.

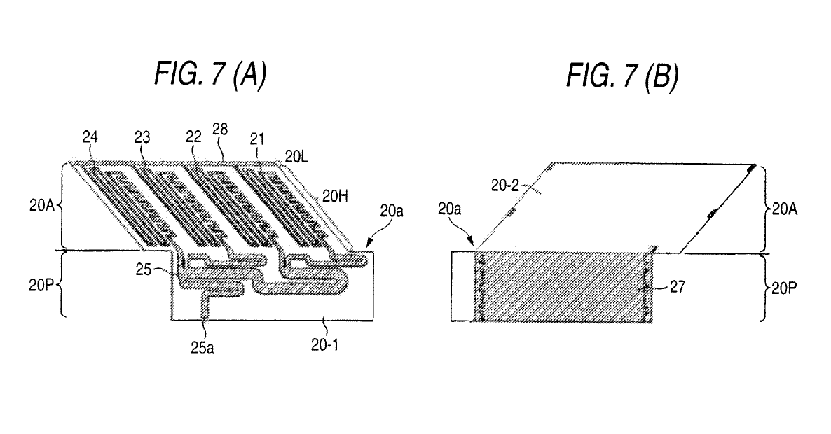

Next, referring to FIGS. 6 and 7, the pole-type antenna module 20 used for the antenna device 10A shown in FIG. 3 is described. FIG. 6 is a front view illustrating an appearance of the pole-type antenna module 20. FIGS. 7(A) and 7(B) are development views of the pole-type antenna module 20 shown in FIG. 6. FIG. 7(A) is a plan view illustrating a first surface (an inner peripheral surface) and FIG. 7(B) is a plan view illustrating a second surface (an outer peripheral surface).

The pole-type antenna module 20 shown in the figure has a cylindrical body 20b formed by winding a flexible dielectric film member 20a shown in FIGS. 7(A) and 7(B) around a central axis in a cylindrical fashion. FIG. 7(A) illustrates a first surface 20-1 of the dielectric film member 20a and FIG. 7(B) illustrates a second surface 20-2 of the dielectric film member 20a.

The dielectric film member 20a is manufactured by using a film made of a low loss dielectric material, for example, a Teflon (registered trademark) series material. An antenna pattern part 20A and a phase shifter part 20P in each of an upper part and a lower part on the first surface 20-1 of the dielectric film member 20a. The antenna patter part 20A has a substantially parallelogram shape and the phase shifter part 20P has a substantially rectangular shape.

The antenna pattern part 20A includes a helical pattern part 20H extending spirally in a longitudinal direction (a direction of the central axis) of the pole-type antenna module 20 and a loop pattern part 20L connected to an end of the helical pattern part 20H in an upper end of the cylindrical body 20b.

The cylindrical body 20b shown in FIG. 6 is formed by winding the dielectric film member 20a so that the first surface 20-1 serves as an inner peripheral surface and connecting a pair of lateral sides to each other. The pair of lateral sides is connected to each other by means of a double-faced adhesive tape, an adhesive agent, or a solder.

A first antenna pattern including first to fourth helical conductors 21, 22, 23, and 24 is formed on a first surface 20-1 of the helical antenna part 20H. The first to fourth helical conductors 21 to 24 shown in the figure extend parallel to the lateral sides with being four times bent in a direction opposite to the longitudinal direction (the direction of the central axis) of the pole-type antenna module 20. In particular, in the first to fourth helical conductors 21 to 24, at least one of five conductor patterns extending parallel to the lateral sides, here, the conductor pattern connected to the phase shifter pattern 25 meanders in a meander shape, that is, in a zigzag.

When the dielectric film member 20a is wound around the cylindrical body 20b as described above, the first to fourth helical conductors 21 to 24 extend on the inner peripheral surface of the cylindrical body 20b in the helix shape with being four times bent in the direction opposite to the longitudinal direction (the direction of the central axis) of the pole-type antenna module 20. A first antenna pattern including the first to fourth helical conductors 21 to 24 acts as a helical antenna.

In this configuration, since the first to fourth helical conductors 21 to 24 are bent in the longitudinal direction of the pole-type antenna module 20 and part of each of the helical conductors is formed in the meander shape, it is possible to increase the lengths of the conductors. Accordingly, it is possible to decrease the height of the pole-type antenna module 20 in comparison with the case in which the helical conductors are not bent.

A second antenna pattern including a loop conductor 28 connected to the distal ends (upper ends) of the first to fourth conductors 21 to 24 is formed on the first surface 20-1 of the loop antenna part 20L. The second antenna pattern including the loop conductor 28 acts as the loop antenna.

The phase shifter pattern 25 electrically connected to the first antenna pattern is formed on the first surface 20-1 of the phase shifter part 20P. Accordingly, when the dielectric film member 20a is wound around the cylindrical body 20b as described above, the phase shifter pattern 25 is formed on the inner peripheral surface of the cylindrical body 20b. The phase shifter pattern 25 acts as a phase shifter.

A ground pattern 27 is formed on a second surface 20-2 of the phase shifter part 20P. That is, the ground pattern 27 is formed on a surface opposite the formation portion of the phase shifter pattern 25. Therefore, when the dielectric film member 20a is wound around the cylindrical body 20b as described above, the ground pattern 27 is formed on the outer peripheral surface of the cylindrical body 20b and the surface opposite the formation portion of the phase shifter pattern 25. The ground pattern 27 acts as the shield member covering the phase shifter pattern 25. An output terminal 25a of the phase shifter pattern 25 is connected to the low noise amplifier (LNA) mounted on the rear surface 30b of the circuit board 30A.

In the antenna device 10A equipped with the pole-type antenna module 20 having the above-mentioned configuration, After a plurality satellite waves (circularly-polarized waves) received through a loop conductor 28 of the loop antenna part 20L and four helical conductors 21 to 24 of the helical antenna part 20H is synthesized by shifting phases of the satellite waves with the phase shifter pattern 25 and matching (adjusting) the phases each other, the synthesized waves are amplified by the low noise amplifier (LNA) mounted on the rear surface 30b of the circuit board 30A and the amplified waves are transmitted to a receiver body 60 (not shown) through a cable (not shown).

In the first embodiment, only the phase shifter pattern part 20P having the ground pattern 27 formed therein is buried below the principal surface 30a of the circuit board 30A (in the shield cover 40). In other words, the antenna pattern part 20A protrudes upward from the principal surface 30a of the circuit board 30A. That is, the antenna pattern part 20A acting as an original antenna in the pole-type antenna module 20 is disposed above the principal surface 30a of the circuit board 30A.

Accordingly, as shown in FIG. 3, even though the pole-type antenna module 20 is mounted on the circuit board 30A with penetrating the through-hole 30c of the circuit board 30A, a performance of the antenna module 20 as the antenna does not deteriorate.

Although the pole-type antenna module 20 is exemplified in FIGS. 6 and 7, the pole-type antenna module 20 is not limited to the above-mentioned first embodiment. For example, although four helical conductors formed on the inner peripheral surface of the cylindrical body are used as the first antenna pattern, the first antenna pattern may include at least two helical conductors. Although the helical conductors constituting the first antenna pattern are four times bent in the direction opposite to the longitudinal direction (the direction of the central axis) of the pole-type antenna module in the first embodiment, the helical conductors may be at least once bent in the opposed direction. Although the ground pattern formed on the outer peripheral surface of the cylindrical body is used as the shield member in the first embodiment, the shield member is not limited to it and may cover the phase shifter pattern.

As described above, the invention is described by the first embodiment, but the invention is not limited to the first embodiment. For example, the receiver described in the first embodiment is the handy digital radio receiver, but the receiver described in the first embodiment is not limited to it and is applicable to a receiver for another use.

Hereinafter, a second embodiment of the invention will be specifically described with reference to the accompanying drawings.

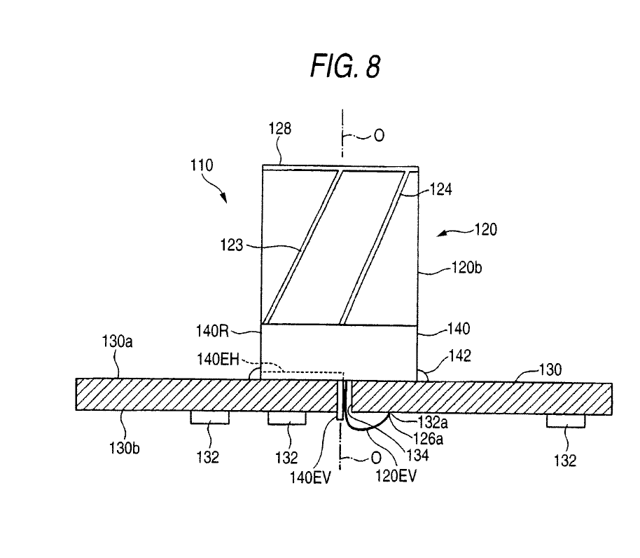

Referring to FIG. 8, an antenna device 110 according to the second embodiment of the invention is described.

The antenna device 110 shown in the figure is an antenna device for a digital radio receiver. The antenna device 110 is connected to a digital radio tuner (not shown) built in a cylindrical body of a mobile electronic apparatus (not shown) through a cable (not shown) and a connector (not shown).

The antenna device 110 shown in the figure includes a pole-type antenna module 120, a circuit board 130, and a metallic attachment bracket (holder) 140.

The circuit board 130 includes a principal surface (a top surface) 130a and a rear surface (a bottom surface) 130b opposed to each other. The pole-type antenna module 120 is mounted on the principal surface 130a of the circuit board 130 as described below. A plurality of circuit components 132 for a low noise amplifier (LNA) is mounted on the rear surface 130b of the circuit board 130. Accordingly, the circuit board 130 is also called an “LNA board”. The plurality of circuit components 132 for the LNA is covered with a shield cover (not shown) attached to the rear surface 130b of the circuit board 130. As described above, the circuit board 130 has the LNA mounted thereon and thus, the circuit board 130 is also called the LNA board.

The pole-type antenna module 120 is extended vertically along a central axis O and is mounted on the principal surface 130a of the LNA board 130 as described below. The pole-type antenna module 120 includes a cylindrical body 120b formed by winding a flexible dielectric film member 120a to be described below about the central axis O.

The metallic attachment bracket (holder) 140 is a member supporting an outer peripheral surface of a lower end of the cylindrical body 120b of the pole-type antenna module 120 so as to attach the pole-type antenna module 120 onto the principal surface 130a of the LNA board 130. The metallic attachment bracket (holder) 140 is fixed onto the principal surface 130a of the LNA board 130 by a solder 142. In an example shown in FIG. 8, although the solder 142 is disposed in a plurality of locations on an outer peripheral lower end of the attachment bracket (holder) 140, the solder 142 may be disposed all around the outer peripheral lower end of the attachment bracket (holder) 140. A detailed structure (configuration) of the metallic attachment bracket (holder) 140 will be described with reference to the accompanying drawings.

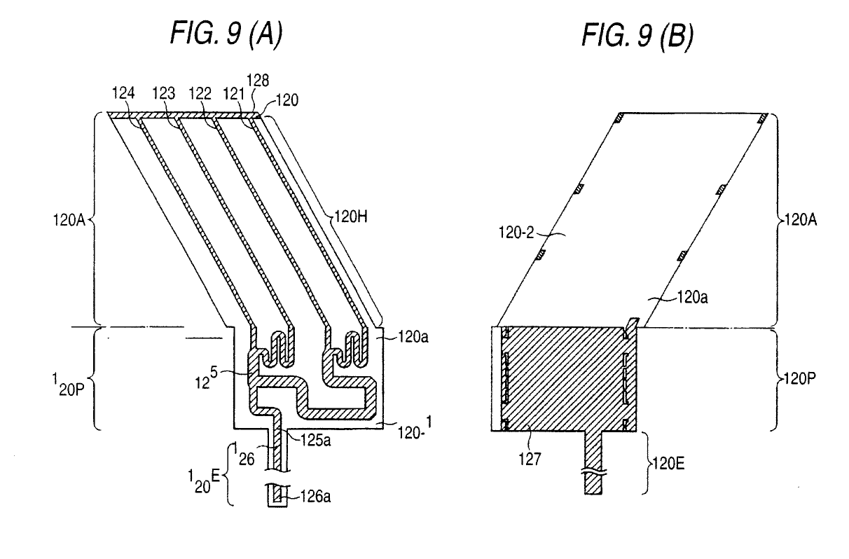

Referring to FIGS. 9(A) and 9(B) in addition to FIG. 8, a first example of the pole-type antenna module 120 used for the antenna device 110 shown in FIG. 8 is described. FIGS. 9(A) and 9(B) are development views of the pole-type antenna module 120. FIG. 9(A) is a plan view illustrating a first surface (an inner peripheral surface) and FIG. 9(B) is a plan view illustrating a second surface (an outer peripheral surface).

The pole-type antenna module 120 shown in the figure has the cylindrical body 120b formed by winding the flexible dielectric film member 120a shown in FIGS. 9(A) and 9(B) about the central axis O. FIG. 9(A) illustrates a first surface 120-1 of the dielectric film member 120a and FIG. 9(B) illustrates a second surface 120-2 of the dielectric film member 120a.

The dielectric film member 120a is manufactured by using a film made of a low loss dielectric material, for example, a Teflon (registered trademark) series material. An antenna pattern part 120A and a phase shifter part 120P are formed in each of a top portion and a bottom portion on the first surface 120-1 of the dielectric film member 120a. The antenna patter part 120A has a substantially parallelogram shape and the phase shifter part 120P has a substantially rectangular shape.

The antenna pattern part 120A includes a helical pattern part 120H extending spirally in a longitudinal direction (a direction of the central axis O) of the pole-type antenna module 120 and a loop pattern part 120L connected to an end of the helical pattern part 120H in an upper end of the cylindrical body 120b.

The cylindrical body 120b shown in FIG. 8 is formed by winding the dielectric film member 120a so that the first surface 120-1 serves as an inner peripheral surface and connecting a pair of lateral sides to each other. The pair of lateral sides is connected to each other by means of a double-faced adhesive tape, an adhesive agent, or a solder.

A first antenna pattern including first to fourth helical conductors 121, 122, 123, and 124 is formed on a first surface 120-1 of the helical antenna part 120H. The first to fourth helical conductors 121 to 124 shown in the figure extend parallel to the lateral sides. Accordingly, when the dielectric film member 120a is wound around the cylindrical body 120b as described above, the first to fourth helical conductors 121 to 124 extend on the inner peripheral surface of the cylindrical body 120b in a helix shape. The first antenna pattern including the first to fourth helical conductors 121 to 124 acts as the helical antenna.

A second antenna pattern including a loop conductor 128 connected to distal ends (top ends) of the first to fourth conductors 121 to 124 is formed on a first surface 120-1 of the loop antenna part 120L. The second antenna pattern including the loop conductor 128 acts as a loop antenna.

A phase shifter pattern 125 electrically connected to the first antenna pattern is formed on a first surface 120-1 of the phase shifter part 120P. Accordingly, when the dielectric film member 120a is wound around the cylindrical body 120b as described above, the phase shifter pattern 125 is formed on the inner peripheral surface of the cylindrical body 120b. The phase shifter pattern 125 serves as a phase shifter.

A ground pattern 127 is formed on a second surface 120-2 of the phase shifter part 120P. That is, the ground pattern 127 is formed on a surface opposed to the formation portion of the phase shifter pattern 125. Therefore, when the dielectric film member 120a is wound around the cylindrical body 120b as described above, the ground pattern 127 is formed on the outer peripheral surface of the cylindrical body 120b and the surface opposed to the formation portion of the phase shifter pattern 125. The ground pattern 127 acts as a shield member covering the phase shifter pattern 125.

The dielectric film member 120a further includes an elongated module extension portion 120E extending downward from the phase shifter part 120P. A transmittance conductor 126 having one end connected to an output terminal 125a of the phase shifter pattern 125 and the other end acting as an output terminal 126a is formed on a first surface 120-1 of the module extension portion 120E. The ground pattern 127 extends on a second surface 120-2 of the module extension portion 120E.

As described above, the antenna device 110 includes the circuit board (the LNA board) 130. Circuit components 132 for the low noise amplifier (LNA) are mounted on the rear surface 130b of the circuit board 130. An input terminal 132a of the low noise amplifier is connected to an output terminal 126a of the pole-type antenna module 120.

After a plurality satellite waves (circularly-polarized waves) received through a loop conductor 128 of the loop antenna part 120L and four helical conductors 121 to 124 of the helical antenna part 120H is synthesized by shifting phases of the satellite waves with the phase shifter pattern 125 and matching (adjusting) the phases each other, the synthesized waves are amplified through the transmittance conductor 126 of the module extension portion 120E by the low noise amplifier (LNA) and the amplified waves are transmitted to a receiver body (not shown) through a cable (not shown).

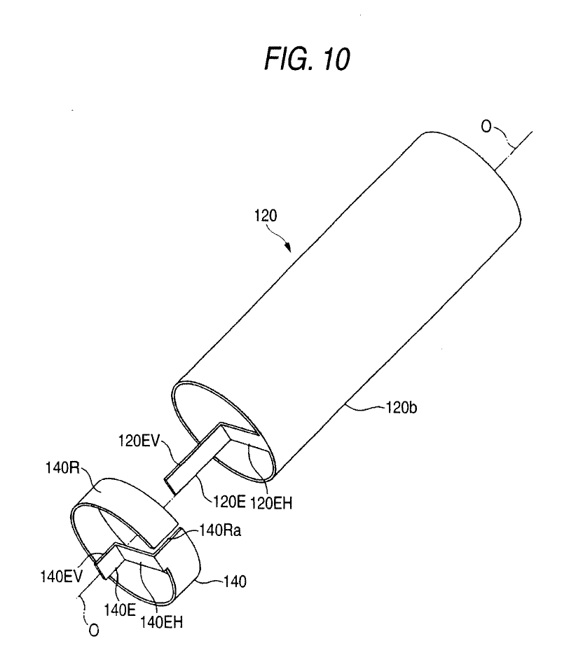

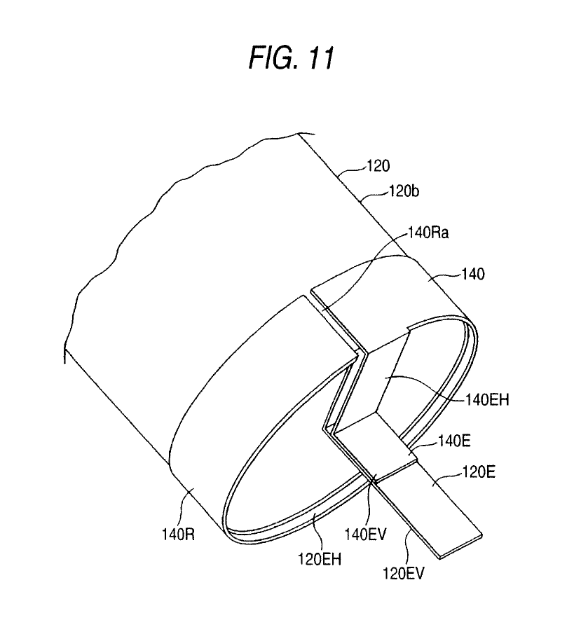

Referring to FIGS. 10 and 11, the pole-type antenna module 120 and the attachment bracket (holder) 140 are described. FIG. 10 is an exploded perspective view illustrating the pole-type antenna module 120 and the attachment bracket (holder) 140. FIG. 11 is a partial enlarged perspective view illustrating a combination status of the pole-type antenna module 120 and the attachment bracket (holder) 140.

The module extension portion 120E of the pole-type antenna module 120 includes a horizontal module extension portion 120EH which is bent vertically from a lower peripheral end of the cylindrical body 120b of the pole-type antenna module 120 toward the inner periphery thereof and a vertical module extension portion 120EV which is vertically bent downward in a direction of a central axis O from a distal end of the horizontal module extension portion 120EH, which is disposed in the vicinity of the central axis O. The module extension portion 120E of the pole-type antenna module 120 has an inverted L shape.

Meanwhile, the attachment bracket (holder) 140 has an inner diameter substantially the same as an outer diameter of the cylindrical body 120b of the pole-type antenna module 120. The attachment bracket (holder) 140 includes a ring-shaped member 140R covering an outer peripheral surface (the ground pattern 127) of a lower end of the cylindrical body 120b and an holder extension portion 140E extending from a predetermined portion of a lower peripheral end of the ring-shaped member 140R. The ring-shaped member 140R has a gap 140Ra around a location where the holder extension portion 140E is disposed.

The holder extension portion 140E includes a horizontal holder extension portion 140EH which is bent vertically from the lower peripheral end of the ring-shaped member 140R toward the inner periphery thereof and a vertical holder extension portion 140EV which is bent vertically downward in a direction of a central axis O from a distal end of the horizontal holder extension portion 140EH, which is disposed in the vicinity of the central axis O. The holder extension portion 140E has the inverted L shape. The vertical holder extension portion 140EV of the holder extension portion 140E has a smaller length than the vertical module extension portion 120EV of the module extension portion 120E.

As shown in FIG. 11, the module extension portion 120E is disposed along the holder extension portion 140E. On the other hand, the holder extension portion 140E is disposed along the module extension portion 120E. The holder extension portion 140E supports the module extension portion 120E. Accordingly, the ground pattern 127 formed on the second surface 120-2 of the module extension portion 120E is electrically to the holder extension portion 140E.

Referring back to FIG. 8, the circuit board (the LNA board) 130 has a through-hole 134 penetrating the principal surface 130a and the rear surface 130b approximately along the central axis O of the pole-type antenna module 120. The through-hole 134 is used for penetrating the vertical module extension portion 120EV of the module extension portion 120E and the vertical holder extension portion 140EV of the holder extension portion 140E. The vertical module extension portion 120EV of the module extension portion 120E is bent as shown in FIG. 8, the output terminal 126a (see FIG. 9(A)) of the pole-type antenna module 120 disposed in a distal end portion of the vertical module extension portion 120EV is connected to the input terminal 132a of the low noise amplifier formed on the rear surface (bottom surface) 130b of the circuit board (the LNA board) 130 by a solder (not shown)

As described above, the pole-type antenna module 120 is attached onto the principal surface 130a of the LNA board 130 by the attachment bracket (holder) 140 with the outer peripheral surface of the lower end of the cylindrical body 120b thereof held. Accordingly, it is possible to vertically erect the pole-type antenna module 120 on the LNA board 130 easily. It is possible to securely attach and fix the pole-type antenna module 120 to and on the LNA board 130 to resist a vibration.

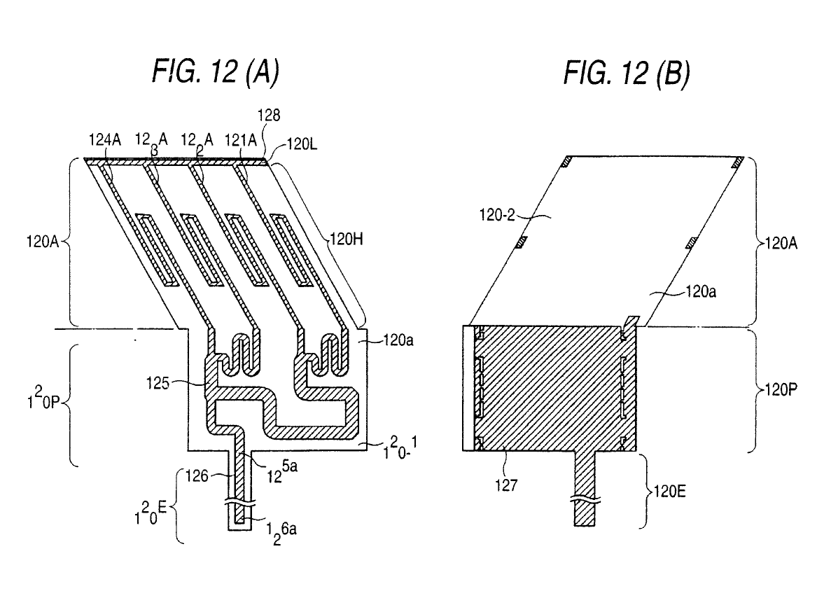

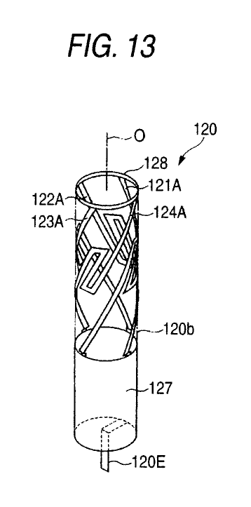

Referring to FIGS. 12 and 13, a second example of the pole-type antenna module 120 used for the antenna device 110 shown in FIG. 8 is described. FIGS. 12(A) and 12(B) are development views of the pole-type antenna module 20. FIG. 12(A) is a plan view illustrating the first surface (the inner peripheral surface) and FIG. 12(B) is a plan view illustrating the second surface (the outer peripheral surface). FIG. 13 is a perspective view of the pole-type antenna module 120.

The pole-type antenna module 120 according to the second example has the same outer shape as those shown in FIGS. 8, 9(A) and 9(B). The pole-type antenna module 120 according to the second example has a shape of a conductor pattern formed on the dielectric film member different from those shown in FIGS. 8, 9(A) and 9(B). Therefore, similar reference numerals are attached to those similar to components of the pole-type antenna module according to the first example.

That is, except a difference in configuration of the first to fourth helical conductors, the pole-type antenna module 120 according to the second example has the same configuration as the pole-type antenna module 120 according to the first example shown in FIGS. 8, 9(A) and 9(B). Accordingly, reference numerals 121A, 122A, 123A, and 124A are attached to the first to fourth helical conductors, respectively.

The pole-type antenna module 120 shown in the figure has the cylindrical body 120b formed by winding the flexible dielectric film member 120a shown in FIGS. 12(A) and 12(B) about the central axis. FIG. 12(A) illustrates the first surface 120-1 of the dielectric film member 120a and FIG. 12(B) illustrates the second surface 120-2 of the dielectric film member 120a.

The dielectric film member 120a is manufactured by using the film made of the low loss dielectric material, for example, the Teflon (registered trademark) series material. The antenna pattern part 120A and the phase shifter part 120P are formed in each of the top portion and the bottom portion on the first surface 120-1 of the dielectric film member 120a. The antenna patter part 120A has the substantially parallelogram shape and the phase shifter part 120P has the substantially rectangular shape.

The antenna pattern part 120A includes the helical pattern part 120H extending spirally in the longitudinal direction (the direction of the central axis) of the pole-type antenna module 120 and the loop pattern part 120L connected to the end of the helical pattern part 120H in the upper end of the cylindrical body 120b.

The cylindrical body 120b shown in FIG. 13 is formed by winding the dielectric film member 120a so that the first surface 120-1 serves as the inner peripheral surface and connecting the pair of lateral sides to each other. The pair of lateral sides is connected to each other by means of the double-faced adhesive tape, the adhesive agent, or the solder.

The first antenna pattern including the first to fourth helical conductors 121A, 122A, 123A, and 124A is formed on the first surface 120-1 of the helical antenna part 120H. The first to fourth helical conductors 121A to 124A shown in the figure extend parallel to the lateral sides with being twice bent in a direction opposed to the longitudinal direction (the direction of the central axis O) of the pole-type antenna module 120. Accordingly, when the dielectric film member 120a is wound around the cylindrical body 120b as described above, the first to fourth helical conductors 121A to 124A extend on the inner peripheral surface of the cylindrical body 120b in the helix shape with being twice bent in the direction opposed to the longitudinal direction (the direction of the central axis O) of the pole-type antenna module 120. The first antenna pattern including the first to fourth helical conductors 121A to 124A acts as the helical antenna.

As described above, in the second example, since the first to fourth helical conductors 121A to 124A are bent in the longitudinal direction of the pole-type antenna module 120, it is possible to decrease the height of the pole-type antenna module in comparison with a case in which the helical conductors are not bent.

The second antenna pattern including the loop conductor 128 connected to distal ends (top ends) of the first to fourth conductors 121A to 124A is formed on the first surface 120-1 of the loop antenna part 120L. The second antenna pattern including the loop conductor 128 acts as the loop antenna.

The phase shifter pattern 125 electrically connected to the first antenna pattern is formed on the first surface 120-1 of the phase shifter part 120P. Accordingly, when the dielectric film member 120a is wound around the cylindrical body 120b as described above, the phase shifter pattern 125 is formed on the inner peripheral surface of the cylindrical body 120b. The phase shifter pattern 125 acts as the phase shifter.

The ground pattern 127 is formed on the second surface 120-2 of the phase shifter part 120P. That is, the ground pattern 127 is formed on the surface opposed to the place where the phase shifter pattern 125 is formed. Therefore, when the dielectric film member 120a is wound around the cylindrical body 120b as described above, the ground pattern 127 is formed on the outer peripheral surface of the cylindrical body 120b and the surface opposed to the place where the phase shifter pattern 125 is formed. The ground pattern 127 acts as the shield member covering the phase shifter pattern 125.

The dielectric film member 120a further includes the elongated module extension portion 120E extending downward from the phase shifter part 120P.

As shown in FIG. 8, the antenna device 110 includes the circuit board (the LNA board) 130. A plurality of circuit components 132 constituting the low noise amplifier (LNA) is mounted on the rear surface 130b of the circuit board 130. The input terminal 132a of the low noise amplifier is connected to the output terminal 126a of the pole-type antenna module 120.

After the plurality satellite waves (the circularly-polarized waves) received through the loop conductor 128 of the loop antenna part 120L and the four helical conductors 121A to 124A of the helical antenna part 120H is synthesized by shifting the phases of the satellite waves with the phase shifter pattern 125 and matching (adjusting) the phases each other, the synthesized waves are amplified through the transmittance conductor 126 of the module extension portion 120E by the low noise amplifier (LNA) and the amplified waves are transmitted to the receiver body (not shown) through the cable (not shown).

The pole-type antenna module 120 shown in FIGS. 12 and 13 is also attached onto the principal surface 130a of the LNA board 130 shown in FIG. 8 by the attachment bracket (holder) 140 shown in FIGS. 10 and 11 with the outer peripheral surface of the lower end of the cylindrical body 120b thereof held. Accordingly, it is possible to vertically erect the pole-type antenna module 120 on the LNA board 130 easily. It is possible to securely attach and fix the pole-type antenna module 120 to and on the LNA board 130 to resist the vibration.

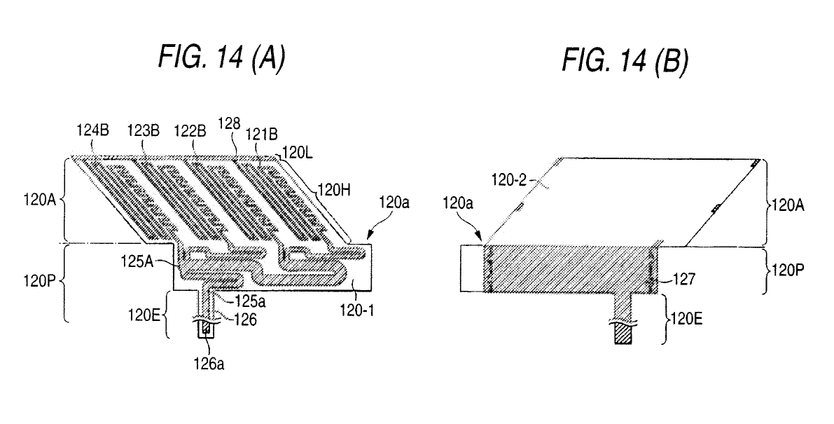

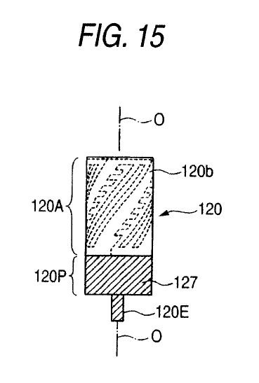

Referring to FIGS. 14 and 15, a third example of the pole-type antenna module 120 used for the antenna device 110 shown in FIG. 8 is described. FIGS. 14(A) and 14(B) are development views of the pole-type antenna module 120. FIG. 14(A) is a plan view illustrating the first surface (the inner peripheral surface) and FIG. 14(B) is a plan view illustrating the second surface (the outer peripheral surface). FIG. 15 is an external view of the pole-type antenna module 120.

The pole-type antenna module 120 according to the third example has the same outer shape as those shown in FIGS. 12(A), 12(B) and 13. The pole-type antenna module 120 according to the third example has the shape of the conductor pattern formed on the dielectric film member different from those shown in FIGS. 12(A), 12(B) and 13. Therefore, similar reference numerals are attached to those similar to components of the pole-type antenna module according to the second example.

That is, except the difference in configuration of the first to fourth helical conductors, the pole-type antenna module 120 according to the third example has the same configuration as the pole-type antenna module 120 according to the second example shown in FIGS. 12(A), 12(B) and 13. Accordingly, reference numerals 121B, 122B, 123B, and 124B are attached to the first to fourth helical conductors, respectively.

The pole-type antenna module 120 according to the third example also has the cylindrical body 120b formed by winding the flexible dielectric film member 120a shown in FIGS. 14(A) and 14(B) about the central axis O. FIG. 14(A) illustrates the first surface 120-1 of the dielectric film member 120a and FIG. 14(B) illustrates the second surface 120-2 of the dielectric film member 120a.

The dielectric film member 120a is manufactured by using the film made of the low loss dielectric material, for example, the Teflon (registered trademark) series material. The antenna pattern part 120A and the phase shifter part 120P are formed in each of the top portion and the bottom portion on the first surface 120-1 of the dielectric film member 120a. The antenna patter part 120A has the substantially parallelogram shape and the phase shifter part 120P has the substantially rectangular shape.

The antenna pattern part 120A includes the helical pattern part 120H extending spirally in the longitudinal direction (the direction of the central axis O) of the pole-type antenna module 120 and the loop pattern part 120L connected to the end of the helical pattern part 120H in the upper end of the cylindrical body 120b.

The cylindrical body 120b shown in FIG. 15 is formed by winding the dielectric film member 120a so that the first surface 120-1 serves as the inner peripheral surface and connecting the pair of lateral sides to each other. The pair of lateral sides is connected to each other by means of the double-faced adhesive tape, the adhesive agent, or the solder.

The first antenna pattern including the first to fourth helical conductors 121B, 122B, 123B, and 124B is formed on the first surface 120-1 of the helical antenna part 120H. The first to fourth helical conductors 121B to 124B shown in the figure extend parallel to the lateral sides with being four times bent in the direction opposed to the longitudinal direction (the direction of the central axis O) of the pole-type antenna module 120. In particular, in the first to fourth helical conductors 121B to 124B, at least one of five conductor patterns extending parallel to the lateral sides, here, the conductor pattern connected to the phase shifter pattern 125A meanders in a meander shape, that is, in a zigzag.

When the dielectric film member 120a is wound around the cylindrical body 120b as described above, the first to fourth helical conductors 121B to 124B extend on the inner peripheral surface of the cylindrical body 120b in the helix shape with being fourth times bent in the direction opposed to the longitudinal direction (the direction of the central axis O) of the pole-type antenna module 120. The first antenna pattern including the first to fourth helical conductors 121B to 124B acts as the helical antenna.

As described above, in the third example, since the first to fourth helical conductors 121B to 124B are bent in the longitudinal direction of the pole-type antenna module 120 and part of each of the helical conductors is formed in the meander shape, it is possible to increase the lengths of the conductors. Accordingly, it is possible to decrease the height of the pole-type antenna module 120 in comparison with the case in which the helical conductors are not bent and the second example.

The second antenna pattern including the loop conductor 128 connected to the distal ends (top ends) of the first to fourth conductors 121B to 124B is formed on the first surface 120-1 of the loop antenna part 120L. The second antenna pattern including the loop conductor 128 acts as the loop antenna.

The phase shifter pattern 125A electrically connected to the first antenna pattern is formed on the first surface 120-1 of the phase shifter part 120P. Accordingly, when the dielectric film member 120a is wound around the cylindrical body 120b as described above, the phase shifter pattern 125A is formed on the inner peripheral surface of the cylindrical body 120b. The phase shifter pattern 125A acts as the phase shifter.

The ground pattern 127 is formed on the second surface 120-2 of the phase shifter part 120P. That is, the ground pattern 127 is formed on the surface opposed to the place where the phase shifter pattern 125A is formed. Therefore, when the dielectric film member 120a is wound around the cylindrical body 120b as described above, the ground pattern 127 is formed on the outer peripheral surface of the cylindrical body 120b and the surface opposed to the place where the phase shifter pattern 125A is formed. The ground pattern 127 acts as the shield member covering the phase shifter pattern 125A.

The dielectric film member 120a further includes the elongated module extension portion 120E extending downward from the phase shifter part 120P.

As shown in FIG. 1, the antenna device 110 includes the circuit board (the LNA board) 130. The plurality of circuit components 132 constituting the low noise amplifier (LNA) is mounted on the rear surface 130b of the circuit board 130. The input terminal 132a of the low noise amplifier is connected to the output terminal 126a of the pole-type antenna module 120.

After the plurality satellite waves (the circularly-polarized waves) received through the loop conductor 128 of the loop antenna part 120L and the four helical conductors 121B to 124B of the helical antenna part 120H is synthesized by shifting the phases of the satellite waves with the phase shifter pattern 125A and matching (adjusting) the phases each other, the synthesized waves are amplified through the transmittance conductor 126 of the module extension portion 120E by the low noise amplifier (LNA) and the amplified waves are transmitted to the receiver body (not shown) through the cable (not shown).

The pole-type antenna module 120 shown in FIGS. 14(A), 14(B) and 15 is also attached onto the principal surface 130a of the LNA board 130 shown in FIG. 8 by the attachment bracket (holder) 140 shown in FIGS. 10 and 11 with the outer peripheral surface of the lower end of the cylindrical body 120b thereof held. Accordingly, it is possible to vertically erect the pole-type antenna module 120 on the LNA board 130 easily. It is possible to securely attach and fix the pole-type antenna module 120 to and on the LNA board 130 to resist the vibration.

Although the pole-type antenna module 120 is described by using the first to third example, the pole-type antenna module 120 is not limited to the pole-type antenna module 120 described in each of the first to third examples described above. For example, although four helical conductors formed on the inner peripheral surface of the cylindrical body are used as the first antenna pattern, the first antenna pattern may include at least two helical conductors. Although the ground pattern formed on the outer peripheral surface of the cylindrical body is used as the shield member in the second embodiment, the shield member is not limited to it and may cover the phase shifter pattern.

As described above, the invention is described by the second embodiment, but the invention is not limited to the above-mentioned second embodiment. For example, the antenna device described in the second embodiment is suitable for a small-sized antenna device for a digital radio receiver, but the antenna device described in the second embodiment is not limited to it and is applicable to an antenna device for a GPS receiver or an antenna device for a mobile communication, which is used for receiving a satellite wave or a terrestrial wave.

What is claimed is:

1. An antenna device comprising:
a circuit board, having a first face and a second face opposite to the first face, the second face on which a low noise amplifier is mounted;
a pole-type antenna module, extending vertically along a central axis thereof; and
a shield cover, attached to the second face of the circuit board so as to cover the low noise amplifier, wherein:
the circuit board is formed with a through hole connecting the first face and the second face; and
the pole-type antenna module is inserted into the through hole so that a lower part thereof is accommodated in the shield cover and an upper part thereof is protruded from the first face of the circuit board.

2. The antenna device as set forth in claim 1, wherein the through hole has substantially the same shape as the outer shape of the pole-type antenna module.

3. The antenna device as set forth in claim 1, wherein the pole-type antenna module includes:
a cylindrical body formed by winding a flexible dielectric film member about the central axis;
an antenna pattern having a plurality of lines of conductors formed on a peripheral surface of the cylindrical body in the upper part;
a phase shifter pattern formed on the peripheral surface of the cylindrical body in the lower part and electrically connected to the antenna pattern.

4. The antenna device as set forth in claim 3, wherein the antenna pattern includes:
a helical pattern spirally extending in a direction of the central axis; and
a loop pattern formed on an upper end of the cylindrical body and electrically connected to an end of the helical pattern.

5. The antenna device as set forth in claim 4, wherein the helical pattern includes a bend portion bent at least once in a direction opposite to the direction of the central axis.

6. The antenna device as set forth in claim 4, wherein the helical pattern includes a meander portion having a meander shape.

7. The antenna device as set forth in claim 3, wherein:
the antenna pattern and the phase shifter pattern are formed on an inner peripheral surface of the cylindrical body; and
the pole-type antenna module further includes ground pattern formed on an outer peripheral surface of the cylindrical body in the lower part.

8. A receiver, comprising:
the antenna device as set forth in claim 1;
a casing, accommodating the antenna device; and
an antenna cover, covering the pole-type antenna module and protruded from an upper end of the casing.

9. An antenna device comprising:
a low noise amplifier board, having a first face and a second face opposite to the first face, the second face on which a low noise amplifier is mounted;
a pole-type antenna module, extending vertically along a central axis thereof and mounted on the first face of the low noise amplifier board, the pole-type antenna module including a cylindrical body formed by winding a flexible dielectric film member about the central axis; and
a metal bracket, supporting an outer peripheral surface of the cylindrical body of the pole-type antenna module so as to attach the pole-type antenna module onto the first face of the low noise amplifier board.

10. The antenna device as set forth in claim 9, wherein the metal bracket has a ring-shaped portion, an inner diameter of which is substantially the same as an outer diameter of the cylindrical body and covering a lower part of the outer peripheral surface of the cylindrical body.

11. The antenna device as set forth in claim 10, wherein:
the pole-type antenna module has an elongated module extension portion extending from a lower peripheral end of the cylindrical body;
the metal bracket has a holder extension portion extending from a lower peripheral end of the ring-shaped portion; and
the holder extension portion is disposed along the module extension portion so as to support the module extension portion.

12. The antenna device as set forth in claim 11, wherein:
the module extension portion includes horizontal module extension portion extending from the lower peripheral end of the cylindrical body toward inside of the cylindrical body and vertical module extension portion extending vertically downward from a tip end of the horizontal module extension portion in a direction of the central axis; and
the holder extension portion includes horizontal holder extension portion extending from the lower peripheral end of the ring-shaped portion toward inside of the ring-shaped portion and vertical module extension portion extending vertically downward from a tip end of the horizontal holder extension portion in the direction of the central axis.

13. The antenna device as set forth in claim 12, wherein the low noise amplifier board is formed with a through hole through into which the vertical module extension portion and the vertical holder extension portion are inserted.

14. The antenna device as set forth in claim 9, wherein the pole-type antenna module includes:
an antenna pattern having a plurality of lines of conductors formed on a peripheral surface of the cylindrical body in an upper part thereof; and
a phase shifter pattern formed on the peripheral surface of the cylindrical body in the lower part and electrically connected to the antenna pattern.

15. The antenna device as set forth in claim 14, wherein the antenna pattern includes:
a helical pattern spirally extending in the direction of the central axis; and
a loop pattern formed on an upper end of the cylindrical body and electrically connected to an end of the helical pattern.

16. The antenna device as set forth in claim 15, wherein the helical pattern includes a bend portion bent at least once in a direction opposite to the direction of the central axis.

17. The antenna device as set forth in claim 15, wherein the helical pattern includes a meander portion having a meander shape.

18. The antenna device as set forth in claim 14, wherein:
the antenna pattern and the phase shifter pattern are formed on an inner peripheral surface of the cylindrical body;
the pole-type antenna module further includes ground pattern formed on the outer peripheral surface of the cylindrical body in the lower part.

19. The antenna device as set forth in claim 18, wherein the ground pattern is electrically connected to the ring-shaped portion of the metal bracket.
